(19) United States
(12) Patent Application Publication
(10) Pub. No.: US 2018/0084807 A1
(43) Pub. Date: Mar. 29, 2018

(54) LIGHTING SYSTEM

(71) Applicant: Panasonic Intellectual Property Management Co., Ltd., Osaka (JP)

(72) Inventors: Shinichi AOKI, Osaka (JP); Yuuki NARUSE, Osaka (JP)

(21) Appl. No.: 15/713,616

(22) Filed: Sep. 23, 2017

(30) Foreign Application Priority Data
Sep. 29, 2016 (JP) 2016-191882

(51) Int. Cl. A23L 3/26; H05B 37/02; F21S 2/00

(52) U.S. Cl. CPC A23L 3/26; F21V 21/15; F21S 2/005; H05B 37/0218

(57) ABSTRACT

A lighting system that irradiates a fresh product with light is provided. The lighting system includes a white light source that emits white light and a near-infrared light source that emits near-infrared light having at least one peak wavelength in a wavelength range of from 700 nm to 1100 nm, inclusive. The near-infrared light at least partially overlaps an area illuminated by the white light on a placement surface on which the fresh product is placed.

### CROSS REFERENCE TO RELATED APPLICATION

This application claims the benefit of priority of Japanese Patent Application Number 2016-191882 filed on Sep. 29, 2016, the entire content of which is hereby incorporated by reference.

### BACKGROUND

### 1. Technical Field

The present disclosure relates to a lighting system that irradiates a fresh product with light.

### 2. Description of the Related Art

Conventionally, techniques for preserving the freshness of a harvested crop (fresh product) have been proposed. One example of a technique for preserving the freshness of a crop is a technique of irradiating a crop with light (for example, see WO 2013/031925).

WO 2013/031925 discloses a technique for preserving the freshness of a crop by irradiating the crop with near-infrared light. Here, a crop is at least one of a fresh vegetable crop (excluding tuberous crops and garlic), a fresh fruit crop, and a fresh flowering crop.

### SUMMARY

The human eye is sensitive to light of wavelengths in a range of from approximately 400 nm to 700 nm, and is increasingly less sensitive to light of wavelengths above or below this range with increasing distance from the range. Near-infrared light includes wavelengths of approximately 700 nm or higher, and as such, is almost completely unperceivable by the human eye.

Moreover, in stores in which crops are sold such as supermarkets and convenient stores, it is probable that the layout of products, such as the crops, will be changed at some point. When the product layout is changed, the illumination position of the near-infrared light also needs to be changed to the new location of the crops, but this is problematic because the illumination position of the near-infrared light is difficult to confirm with the naked eye.

In light of this, the present disclosure provides a lighting system that makes it easier to confirm the illumination position of near-infrared light.

According to one aspect of the present disclosure, a lighting system that irradiates a fresh product with light includes: a white light source that emits white light; and a near-infrared light source that emits near-infrared light having at least one peak wavelength in a wavelength range of from 700 nm to 1100 nm, inclusive, the near-infrared light at least partially overlapping an area illuminated by the white light on a placement surface on which the fresh product is placed.

The lighting system according to the present disclosure makes it easier to confirm the illumination position of near-infrared light.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is a schematic perspective view illustrating the lighting system according to Embodiment 1;

FIG. 2 is a block diagram illustrating the characteristic functional configuration of the lighting system according to Embodiment 1;

FIG. 3 is a schematic side view illustrating a lighting device which is one specific example of the lighting system according to Embodiment 1;

FIG. 4 is a schematic perspective view illustrating Variation 1 of the lighting system according to Embodiment 1;

FIG. 5 is a schematic side view illustrating Variation 2 of the lighting system according to Embodiment 1;

FIG. 6 is a schematic side view illustrating Variation 3 of the lighting system according to Embodiment 1;

FIG. 7 is a block diagram illustrating the characteristic functional configuration of the lighting system according to Embodiment 2;

FIG. 8 is a schematic side view illustrating the lighting system according to Embodiment 2;

FIG. 9 is a flow chart illustrating the order of processes for detecting near-infrared light in the lighting system according to Embodiment 2;

FIG. 10 is a block diagram illustrating the characteristic functional configuration of the lighting system according to Embodiment 3;

FIG. 11 is a schematic perspective view illustrating the lighting system according to Embodiment 3;

FIG. 12 is a flow chart illustrating the order of processes for changing the emission direction in the lighting system according to Embodiment 3; and

FIG. 13 is a schematic side view illustrating a lighting system according to another embodiment.

### DETAILED DESCRIPTION OF THE EMBODIMENTS

The following describes a lighting system according to embodiments with reference to the drawings. Note that each embodiment described below shows a general or specific example of the present disclosure. The numerical values, shapes, materials, elements, the arrangement and connection of the elements, steps, order of the steps etc., indicated in the following embodiments are mere examples, and therefore do not intend to limit the present disclosure. Therefore, among elements in the following embodiments, those not recited in any of the independent claims defining the broadest inventive concept are described as optional elements.

Note that the figures are schematic drawings, and are not necessarily exact depictions. In the figures, elements having essentially the same configuration share like reference numbers. Accordingly, overlapping descriptions thereof are omitted or simplified.

In the description, the Z axis extends vertically, and the positive direction along the Z axis is defined as “up”. The X and Y axes are orthogonal to the Z axis. The X axis is orthogonal to the Y axis.

Note that in the description, the term “approximately” includes deviations within manufacturing or placement margins of error.

### Embodiment 1

### (Lighting System Configuration)

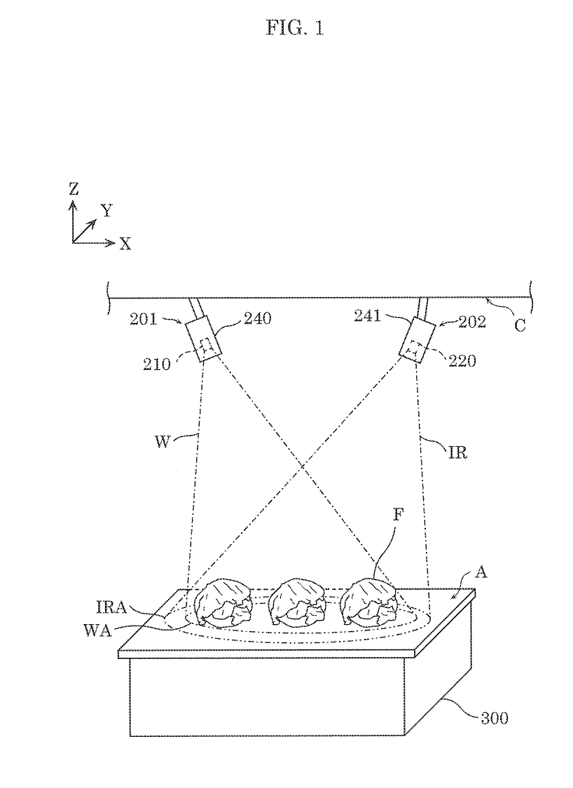

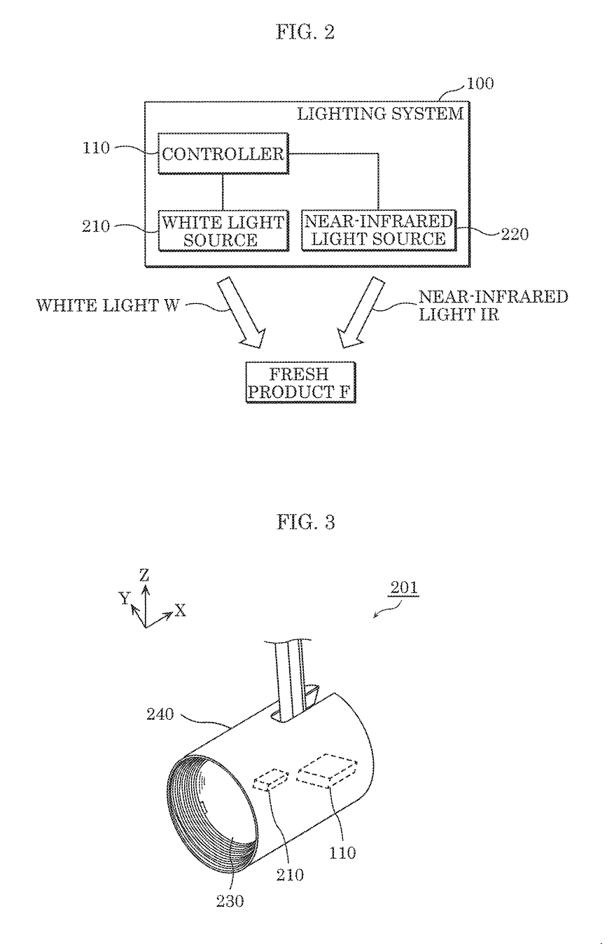

First, the lighting system according to Embodiment 1 will be described. FIG. 1 is a schematic view illustrating the lighting system according to Embodiment 1. FIG. 2 is a block diagram illustrating the characteristic functional configuration of lighting system 100 according to Embodiment 1.

Lighting system 100 according to Embodiment 1 is used in a store, in showcase 300 on which fresh product F is displayed, or in a factory in which fresh product F is processed. For example, as illustrated in FIG. 1, fresh product F displayed (placed) on placement surface A of showcase 300 is irradiated with near-infrared light IR and white light W. In other words, as illustrated in FIG. 2, lighting system 100 is used to irradiate fresh product F with white light W emitted by white light source 210 and near-infrared light IR emitted by near-infrared light source 220. Here, fresh product F is, for example, a fresh vegetable crop such as cabbage or lettuce, a fresh fruit crop such as a strawberry or apple, and/or a fresh flowering crop such as a carnation. White light W is emitted to allow, for example, a consumer buying fresh product F to see fresh product F. Near-infrared light IR is emitted to inhibit deterioration (reduction in freshness) of fresh product F.

In FIG. 1, white light source 210 and near-infrared light source 220 are disposed in separate enclosures, and lighting device 201 that emits white light W and lighting device 202 that emits near-infrared light IR are installed on ceiling C.

The amount of light required from the light emitted by lighting device 201 and the amount of light required from the light emitted by lighting device 202 differ due to differences between the distance from lighting device 201 to fresh product F and the distance from lighting device 202 to fresh product F. By disposing white light source 210 and near-infrared light source 220 in separate enclosures, it is easier to make adjustments such as changing the number of white light sources 210 and near-infrared light sources 220 disposed in the enclosures and changing the number of lighting devices 201 and 202 installed on ceiling C. In other words, the amount of white light W and the amount of near-infrared light IR required for fresh product F are easier to individually adjust. Note that white light source 210 and near-infrared light source 220 need not be disposed in separate enclosures. As illustrated in FIG. 2, lighting system 100 includes white light source 210, near-infrared light source 220, and controller 110.

Lighting device 201 emits white light W toward fresh product F. Lighting device 201 includes one or more white light sources 210 in first enclosure 240.

White light source 210 emits white light W, which is visible light, for ensuring, for example, the visibility and appealing appearance of fresh product F. More specifically, white light source 210 emits white light W that illuminates white light illumination area WA on placement surface A on which fresh product F is placed. In other words, white light source 210 emits white light W that illuminates the area that is surrounded by the line of alternating long and two short dashes on placement surface A and indicated as white light illumination area WA in FIG. 1. White light source 210 is not limited to any particular type of light source, and may be any type of light source that emits white light W. For example, white light source 210 is a fluorescent light or light-emitting diode (LED). One example of an LED that emits white light W includes an indium gallium nitride (InGaN) blue diode that emits blue light and an yttrium aluminum garnet (YAG) phosphor that absorbs and converts the blue light from the diode and emits yellow light. White light W is produced as a result of the yellow light from the phosphor and the blue light not absorbed by the phosphor mixing together.

Note that when lighting device 201 includes a plurality of white light sources 210, white light illumination area WA refers to the collective area illuminated by the white light W emitted by each white light source 210. Moreover, the cutoff for the boundary of white light illumination area WA is where the light intensity is equal to 1/e² the maximum light intensity in white light illumination area WA.

Lighting device 202 emits near-infrared light IR for preserving the freshness of fresh product F toward fresh product F. For example, lighting device 202 emits near-infrared light IR at a light output of approximately 30 mW/m² to preserve the freshness of fresh product F. Lighting device 202 includes one or more near-infrared light sources 220 in second enclosure 241.

Near-infrared light source 220 emits near-infrared light IR. More specifically, near-infrared light source 220 emits near-infrared light IR that illuminates near-infrared light illumination area IRA on placement surface A on which fresh product F is placed. In other words, near-infrared light source 220 emits near-infrared light IR that illuminates the area that is surrounded by the line of alternating long and two short dashes on placement surface A and indicated as near-infrared light illumination area IRA in FIG. 1. Near-infrared light IR has at least one peak wavelength in a range of from 700 nm to 1100 nm, inclusive. For example, near-infrared light IR may have a maximum peak wavelength in a range of from 700 nm to 1100 nm, inclusive. Further, near-infrared light IR may have a maximum peak wavelength at approximately 735 nm±20 nm. Near-infrared light source 220 is not limited to any particular type of light source, and may be any type of light source that emits near-infrared light IR. For example, near-infrared light source 220 is a fluorescent light or light-emitting diode (LED). One example of an LED that emits near-infrared light IR is an aluminum gallium arsenide (AlGaAs) diode.

Near-infrared light source 220 is installed on ceiling C of, for example, a store that sells fresh product F. The freshness of fresh product F is preserved longer when fresh product F is irradiated with near-infrared light IR by near-infrared light source 220 than when fresh product F is not irradiated by near-infrared light IR.

Note that when lighting device 202 includes a plurality of near-infrared light sources 220, near-infrared light illumination area IRA refers to the collective area illuminated by the near-infrared light IR emitted by each near-infrared light source 220. Moreover, the cutoff for the boundary of near-infrared light illumination area IRA is where the light intensity is equal to 1/e² the maximum light intensity in near-infrared light illumination area IRA.

Here, one characteristic of lighting system 100 according to Embodiment 1 is that near-infrared light IR is emitted so as to at least partially overlap white light illumination area WA on placement surface A. Stated differently, on placement surface A, near-infrared light IR is emitted such that near-infrared light illumination area IRA at least partially overlaps white light illumination area WA. More specifically, for example, near-infrared light illumination area IRA may overlap at least 90% of white light illumination area WA. Moreover, for example, on placement surface A, near-infrared light illumination area IRA may completely cover white light illumination area WA. Fresh product F is irradiated with near-infrared light IR as a result of being displayed on placement surface A illuminated by visible white light W. In other words, placing fresh product F inside white light illumination area WA results in fresh product F being irradiated by near-infrared light IR. Accordingly, the area illuminated by near-infrared light IR, which is difficult to see, can be known without having to confirm the illumination position of near-infrared light IR. Note that the areas defined as white light illumination area WA and near-infrared light illumination area IRA are defined in a state in which fresh product F is not displayed on placement surface A.

Controller 110 is a printed circuit board having a control circuit formed thereon. Controller 110 controls the emission of light by white light source 210 and near-infrared light source 220. More specifically, controller 110 controls the amount of power input to white light source 210 and near-infrared light source 220. Note that controller 110 may be configured of memory and a central processing unit (CPU) that executes a control program stored in the memory. The memory may be, for example read only memory (ROM), random access memory (RAM), and/or a hard disk drive (HDD).

Note that when white light source 210 and near-infrared light source 220 are disposed in separate enclosures, as is the case in the example illustrated in FIG. 1, controller 110 may be installed in each enclosure.

FIG. 3 is a perspective view illustrating a lighting device which is one specific example of the lighting system according to Embodiment 1. Note that since lighting device 201 including white light source 210 and lighting device 202 including near-infrared light source 220 may have essentially the same configuration, lighting device 201 including white light source 210 in FIG. 3 will be described.

Lighting device 201 includes first enclosure 240, white light source 210, controller 110, and optical component 230.

First enclosure 240 is a case for housing white light source 210, controller 110, and optical component 230. First enclosure 240 is formed using a metal material, but may be formed using a different material, such as a resin material.

Optical component 230 is a cover component that transmits white light W emitted by white light source 210. Note that when the near-infrared light source is disposed in the lighting device, the optical component is a cover component that transmits the near-infrared light. For example, optical component 230 can be formed from a glass material or a resin material such as acrylic or polycarbonate. Moreover, optical component 230 includes a function of focusing white light W. More specifically, optical component 230 emits a spot light onto placement surface A by focusing and emitting white light W from white light source 210. In this case, optical component 230 is, for example, a lens. Note that when the near-infrared light source is disposed in the lighting device, the optical component includes a function of focusing the near-infrared light.

Moreover, lighting device 201 may include a power source unit (not illustrated in the drawings) that supplies power for causing white light source 210 to emit light. For example, the power source unit converts alternating current power from a utility power source into direct current power and outputs the converted power to white light source 210 and near-infrared light source 220. When the amount (light output) of white light W emitted by white light source 210 is to be adjusted, for example, controller 110 adjusts the amount of white light W by adjusting the amount of direct current power converted by the power source unit.

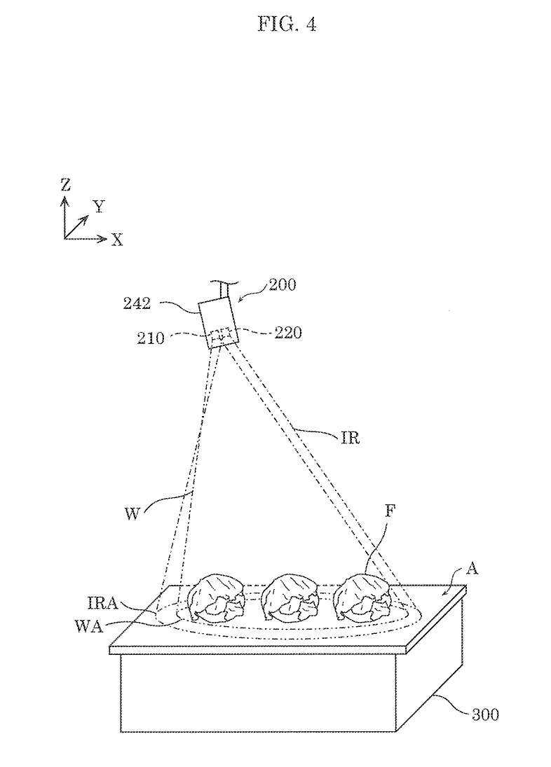

FIG. 4 illustrates the lighting system according to Variation 1 of Embodiment 1.

As described above, lighting system 100 according to Embodiment 1 includes separate lighting devices including separate enclosures in which white light source 210 and near-infrared light source 220 are separately disposed. However, lighting system 100 is not limited to this example. As illustrated in FIG. 4, white light source 210 and near-infrared light source 220 may be disposed in a common third enclosure 242 included in lighting device 200. In other words, lighting system 100 may be a single lighting device that emits both white light W and near-infrared light IR.

With this, the illumination positions of white light W and near-infrared light IR can be easily set merely by presetting, in a manufacturing process of lighting device 200, near-infrared light illumination area IRA and white light illumination area WA so as to overlap as described above one time, by, for example, adjusting the arrangement of white light source 210 and near-infrared light source 220 in lighting device 200. In other words, even when the installation location of lighting device 200 is changed, white light W and near-infrared light IR are emitted from lighting device 200 such that near-infrared light illumination area IRA and white light illumination area WA overlap.

Note that third enclosure 242 may include a conventional adjustment mechanism which allows the optical axis of white light W emitted by white light source 210 and the optical axis of near-infrared light IR emitted by near-infrared light source 220 to be adjusted.

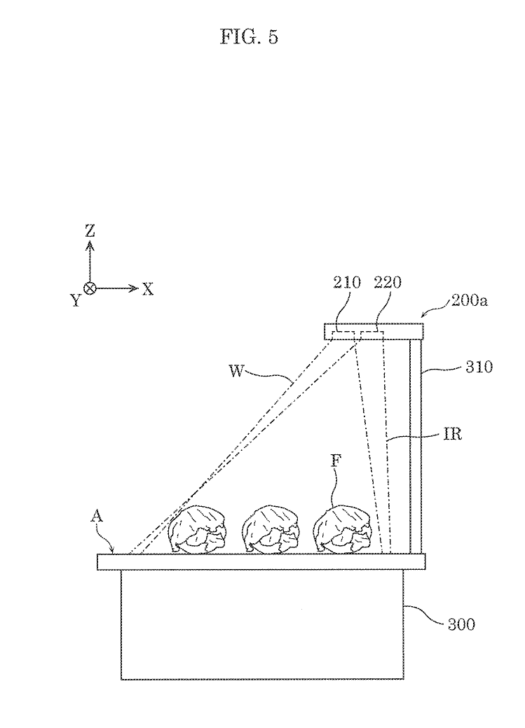

FIG. 5 illustrates the lighting system according to Variation 2 of Embodiment 1.

For example, lighting devices 201 and 202 illustrated in FIG. 1 are installed on ceiling C of, for example, a store. However, as illustrated in FIG. 5, lighting device 200a that emits both white light W and near-infrared light IR may be installed on showcase 300. More specifically, lighting device 200a may be installed above showcase 300 via pillar component 310. With this, the distance between lighting device 200a and fresh product F is less than when lighting device 200a is installed on ceiling C. Accordingly, lighting device 200a can irradiate fresh product F with the required amount of white light W and near-infrared light IR even with a little amount of light. In other words, the amount of energy consumed by lighting device 200a is reduced.

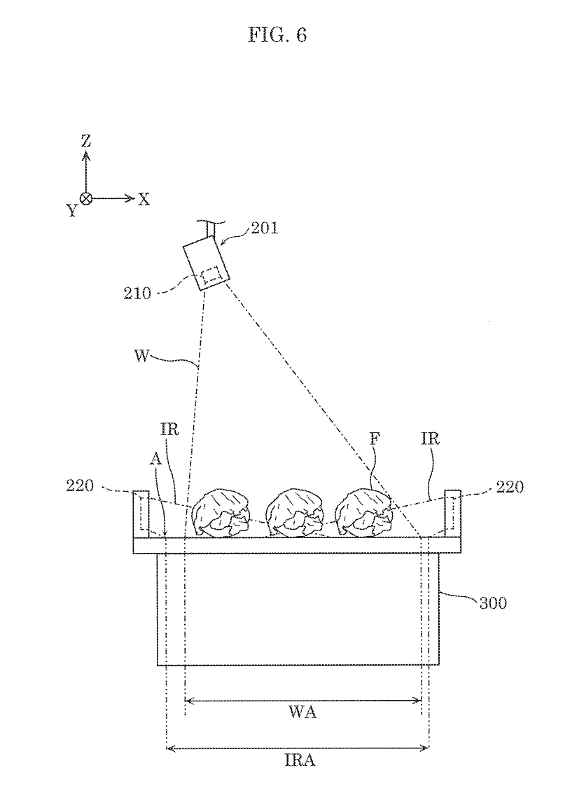

FIG. 6 illustrates the lighting system according to Variation 3 of Embodiment 1.

For example, in the lighting system according to Variation 2 of Embodiment 1 illustrated in FIG. 5, lighting device 200a that emits both white light W and near-infrared light IR is installed on showcase 300. However, in FIG. 6, near-infrared light source 220 is installed on showcase 300 while white light source 210 is installed above (for example, in the store ceiling) showcase 300. More specifically, near-infrared light IR irradiates fresh product F from the sides while white light W irradiates fresh product F from above. Moreover, the area of placement surface A illuminated by near-infrared light IR completely covers the area of placement surface A illuminated by white light W. Here, as illustrated in FIG. 6, near-infrared light illumination area IRA is the area of placement surface A collectively illuminated by near-infrared light IR emitted from the plurality of near-infrared light sources 220. This ensures that the area illuminated by light from near-infrared light source 220 installed on showcase 300 is formed. In other words, it is possible to adjust near-infrared light illumination area IRA so as to completely cover white light illumination area WA simply by adjusting the area illuminated by light from white light source 210 installed on ceiling C.

Note that lighting system 100 may be configured such that either white light source 210 or near-infrared light source 220 is installed on showcase 300. More specifically, in lighting system 100, white light source 210 may be installed on showcase 300 and near-infrared light source 220 may be installed above (for example, on the store ceiling) showcase 300.

This ensures that the area illuminated by light from whichever one of white light source 210 and near-infrared light source 220 is installed on showcase 300 is formed. In other words, it is possible to adjust near-infrared light illumination area IRA so as to overlap white light illumination area WA simply by adjusting the area illuminated by light from whichever one of white light source 210 and near-infrared light source 220 is installed on ceiling C.

Note that in FIG. 6, near-infrared light IR is exemplified as, but not limited to, irradiating fresh product F from the sides; near-infrared light source 220 may be disposed below fresh product F and irradiate fresh product F with near-infrared light IR from below.

Lighting system 100 according to Embodiment 1 irradiates fresh product F with light and includes: white light source 210 that emits white light W; and near-infrared light source 220 that emits near-infrared light IR having at least one peak wavelength in a wavelength range of from 700 nm to 1100 nm, inclusive, near-infrared light IR at least partially overlapping an area illuminated by white light W on placement surface A on which fresh product F is placed.

### Advantageous Effects, Etc

With this, the area illuminated by near-infrared light IR, which is difficult to visually confirm, can be known without having to confirm the illumination position of near-infrared light IR. More specifically, fresh product F is irradiated with near-infrared light IR when displayed on placement surface A illuminated by white light W, which is visually confirmable. Accordingly, lighting system 100 makes it easier to confirm the illumination position of the near-infrared light.

Moreover, white light source 210 may be disposed in first enclosure 240 and near-infrared light source 220 may be disposed in second enclosure 241 different from first enclosure 240. In other words, white light source 210 and near-infrared light source 220 may be disposed in separate enclosures.

With this, the amount of white light W and the amount of near-infrared light IR required for fresh product F are easier to individually adjust.

Moreover white light source 210 and near-infrared light source 220 may be disposed in third enclosure 242. In other words, white light source 210 and near-infrared light source 220 may be disposed in the same enclosure.

With this, near-infrared light IR and white light W are emitted such that near-infrared light illumination area IRA overlaps white light illumination area WA as described above, merely by setting, for example, the arrangement of white light source 210 and near-infrared light source 220 in lighting device 200. Accordingly, lighting device 200 can be realized that emits near-infrared light IR and white light W such that near-infrared light illumination area IRA overlaps white light illumination area WA even when the installation location of lighting device 200 changes.

Moreover, lighting system 100 may include optical component 230 that focuses white light W and near-infrared light IR. Stated differently, optical component 230 may emit a spot light onto placement surface A by emitting and focusing white light W and near-infrared light IR.

With this, fresh product F is efficiently irradiated with white light W and near-infrared light IR. In other words, white light W and near-infrared light IR can be inhibited from illuminating areas other than where fresh product F is placed, i.e., in areas where white light W and near-infrared light IR need not be emitted. Accordingly, fresh product F can be irradiated without wastefully using white light W and near-infrared light IR.

### Embodiment 2

With a lighting system such as the one described in Embodiment 1, it is possible to easily confirm the area illuminated by near-infrared light IR. However, when near-infrared light IR is not being emitted, such as when near-infrared light source 220 is out of order, the emission of near-infrared light IR cannot be confirmed since near-infrared light IR is not visible to the human eye. In Embodiment 2, the lighting system further includes a photosensor that detects the emission of light by near-infrared light source 220. Note that elements that are essentially the same as in Embodiment 1 share like reference signs, and overlapping description thereof is omitted or simplified.

### (Lighting System Configuration)

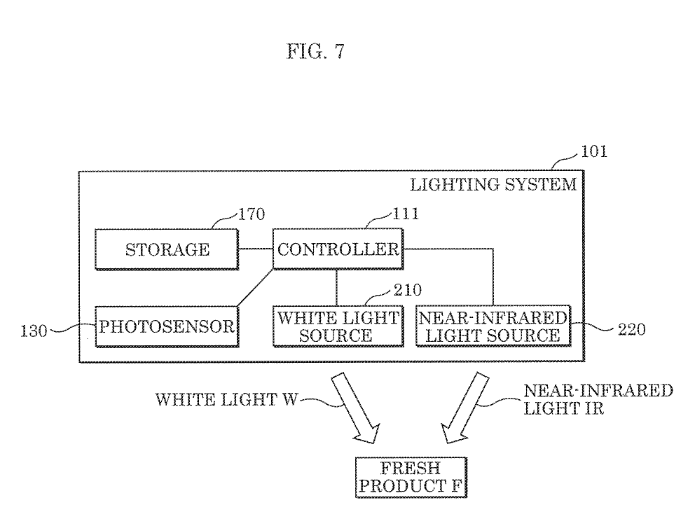

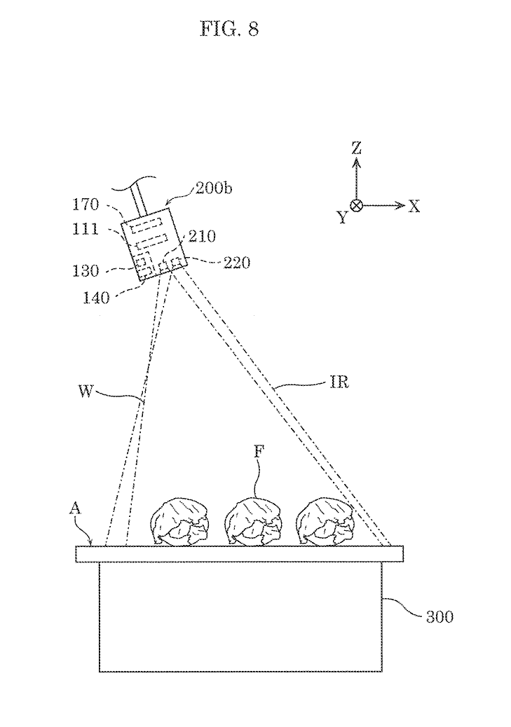

FIG. 7 is a block diagram illustrating the characteristic functional configuration of lighting system 101 according to Embodiment 2. FIG. 8 is a schematic side view of lighting system 101 according to Embodiment 2.

As illustrated in FIG. 7, lighting system 101 includes white light source 210, near-infrared light source 220, storage 170, controller 111, and photosensor 130.

Storage 170 is memory that stores, for example, a control program executed by controller 111. For example, storage 170 is configured of ROM and/or RAM.

Controller 111 is a printed circuit board having a control circuit formed thereon. Controller 111 controls the emission of light by white light source 210 and near-infrared light source 220. More specifically, controller 111 controls the amount of power input to white light source 210 and near-infrared light source 220. Controller 111 includes a function of controlling photosensor 130 in addition to the functions of controller 110 indicated in Embodiment 1. More specifically, upon using photosensor 130 to detect near-infrared light IR, controller 111 causes white light source 210 to stop emitting light. Note that controller 111 may be a CPU that executes a control program stored in storage 170.

Then, when photosensor 130 detects near-infrared light IR, controller 111 causes white light source 210 to emit light. When photosensor 130 does not detect near-infrared light IR, controller 111 causes white light source 210 to blink white light W.

Photosensor 130 is an imaging element that detects near-infrared light IR. In other words, photosensor 130 is an imaging element for detecting near-infrared light IR emitted by near-infrared light source 220. More specifically, photosensor 130 detects at least light of wavelengths from 700 nm to 1100 nm, inclusive. Photosensor 130 is, for example, a photodiode (PD). Moreover, photosensor 130 may be an image sensor such as a charge coupled device (CCD) or a complementary metal oxide semiconductor (CMOS).

As illustrated in FIG. 8, lighting device 200b, which is one specific example of lighting system 101 according to Embodiment 2, includes white light source 210, near-infrared light source 220, controller 111, storage 170, photosensor 130, and optical filter 140.

Optical filter 140 is an optical element that blocks light so as to prevent transmission of light of certain wavelengths. More specifically, optical filter 140 blocks light of wavelengths less than 700 nm, and transmits light of wavelengths greater than or equal to 700 nm. For example, a glass material having a multi-layer film formed on the surface is used as optical filter 140. Moreover, optical filter 140 is disposed on the side of photosensor 130 that receives white light W. In FIG. 8, in order to prevent the light emitted by white light source 210 and near-infrared light source 220 from being directly incident on photosensor 130, a divider is provided inside lighting device 200b, between (i) photosensor 130 and (ii) white light source 210 and near-infrared light source 220. In other words, photosensor 130 is installed in lighting device 200b so as to detect near-infrared light IR reflected from fresh product F.

Moreover, optical filter 140 is disposed on the side of photosensor 130 that receives white light W and near-infrared light IR, which is on the showcase 300 side from the perspective of photosensor 130. This inhibits white light W, which is noise to photosensor 130, from being incident on photosensor 130, and allows photosensor 130 to accurately detect near-infrared light IR.

Next, processes performed by controller 111 up to the detection of whether near-infrared light IR is being emitted or not will be described.

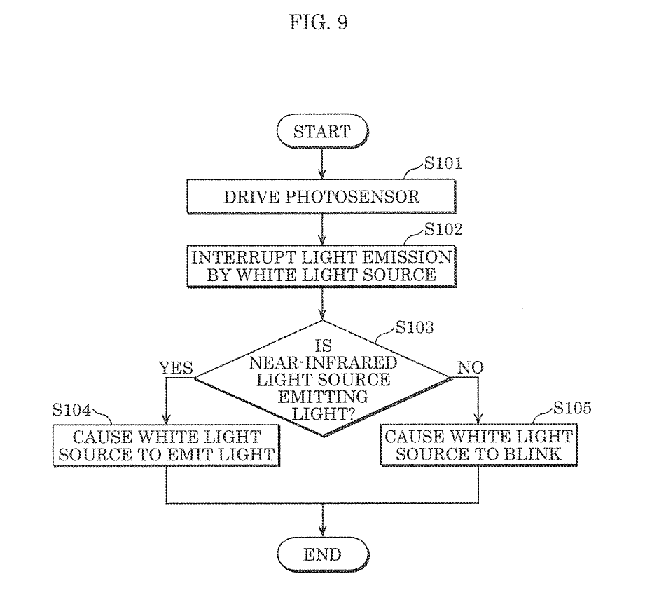

FIG. 9 is a flow chart illustrating the order of processes for detecting near-infrared light IR in the lighting system according to Embodiment 2.

Controller 111 detects whether near-infrared light IR is being emitted or not based on a control program stored in advance in storage 170, including date and time information such as the date and time for detecting whether near-infrared light IR is being emitted or not. Controller 111 drives photosensor 130 based on date and time information included in the control program (step S101). Next, controller 111 interrupts the emission of light by white light source 210 (step S102). Photosensor 130 detects whether near-infrared light IR is being emitted or not (step S103). For example, when photosensor 130 detects near-infrared light IR (Yes in S103), controller 111 causes white light source 210 to emit light (step S104). Here, causing white light source 210 to emit light means causing white light source 210 to continuously emit light. Moreover, when photosensor 130 does not detect near-infrared light IR (No in S103), controller 111 causes white light source 210 to blink white light W (step S105). With this, the user can easily confirm whether near-infrared light IR is being emitted or not even though near-infrared light IR is not visible. Note that “the user” is a user of lighting system 101 according to this embodiment.

Note that controller 111 is exemplified as, but not limited to, causing white light source 210 to blink white light W when photosensor 130 does not detect near-infrared light IR; so long as the user can confirm that near-infrared light IR is not being emitted, the method is not particularly limited. For example, when photosensor 130 does not detect near-infrared light IR, controller 111 may cause white light source 210 to emit white light W in a lower amount than when near-infrared light IR is detected by photosensor 130.

More specifically, when photosensor 130 detects near-infrared light IR (Yes in step S103), controller 111 causes white light source 210 to resume emitting white light at the same intensity as before emission by white light source 210 was interrupted (corresponding to step S104). When photosensor 130 does not detect near-infrared light IR (No in S103), controller 111 causes white light source 210 to reduce the intensity of white light W to below the light intensity before emission by white light source 210 was interrupted (corresponding to step S105).

It should be noted that white light W is known to facilitate deterioration of fresh product F. As described above, when photosensor 130 does not detect near-infrared light IR, controller 111 causes white light source 210 to reduce the intensity of white light W to below the light intensity before emission by white light source 210 was interrupted to inhibit deterioration of fresh product F. In other words, it is possible to mitigate the deterioration of fresh product F resulting from fresh product F not being irradiated with near-infrared light IR. Moreover, by reducing the intensity of white light W, compared to before the intensity of white light W was reduced, the white light illumination area WA appears slightly dark to the user. In other words, the user can confirm that near-infrared light IR is not being emitted from the intensity of white light W.

Moreover, lighting system 101 may include a notifier (not illustrated in the drawings) and controller 111 may notify the user that near-infrared light IR is not being emitted when photosensor 130 does not detect near-infrared light IR. The notifier may be, for example, a light source that emits light or a speaker that emits sound, and may notify the user with the emitted light or sound that near-infrared light IR is not being emitted.

Moreover, the position of photosensor 130 is not particularly limited, and need not be disposed in lighting device 200b so as to detect near-infrared light IR reflected from fresh product F. For example, photosensor 130 may be installed on showcase 300. More specifically, photosensor 130 can detect near-infrared light IR directly incident on photosensor 130 and not near-infrared light IR from near-infrared light source 220 that has been reflected. With this, since light loss that occurs when near-infrared light IR is reflected is eliminated, photosensor 130 can more easily detect near-infrared light IR even when the light output (amount of light) of near-infrared light IR is low. Moreover, photosensor 130 may be disposed in the vicinity of near-infrared light source 220 such that near-infrared light IR is directly incident on photosensor 130 and white light W is not incident on photosensor 130.

### Advantageous Effects, Etc

Lighting system 101 according to Embodiment 2 includes photosensor 130 that detects at least light of wavelengths from 700 nm to 1100 nm, inclusive.

With this, photosensor 130 can detect whether near-infrared light IR is being emitted or not by near-infrared light source 220. Accordingly, the user can confirm whether near-infrared light IR, which is almost completely invisible, is being emitted or not.

Moreover, controller 111 may interrupt emission of light by white light source 210 and then cause photosensor 130 to detect light.

With this, when photosensor 130 detects near-infrared light IR, white light W, which may be noise to photosensor 130, can be inhibited from being incident on photosensor 130. Accordingly, photosensor 130 can precisely measure near-infrared light IR.

Moreover, controller 111 may cause white light source 210 to emit light when photosensor 130 detects near-infrared light IR and may cause white light W to blink when photosensor 130 does not detect near-infrared light IR.

With this, when near-infrared light IR is not being emitted, the user can be notified that near-infrared light IR is not being emitted with a simple configuration.

Moreover, lighting system 101 may further include optical filter 140 that blocks light less than 700 nm in wavelength. Moreover, optical filter 140 may be located on the side of photosensor 130 that receives white light W.

With this, optical filter 140 can inhibit light other than near-infrared light IR that may cause noise from being incident on photosensor 130. Accordingly, photosensor 130 can even more precisely measure near-infrared light IR.

### Embodiment 3

In the lighting systems according to Embodiments 1 and 2 described above, white light W and near-infrared light IR are emitted such that near-infrared light illumination area IRA overlaps white light illumination area WA. Here, for example, when the layout in a store changes, there is a need to change the emission directions of white light W and near-infrared light IR emitted by the lighting device(s) in the lighting system, or move the positions of the lighting device(s). The lighting system according to Embodiment 3 includes, in addition to the elements included in the lighting system according to Embodiment 1, a communication unit and a movable component. The communication unit obtains positional information indicating where in the store a fresh product is, and the movable component changes the emission directions of white light W and near-infrared light IR based on the positional information. Note that elements that are essentially the same as in Embodiment 1 and 2 share like reference signs, and overlapping description thereof is omitted or simplified.

### (Lighting System Configuration)

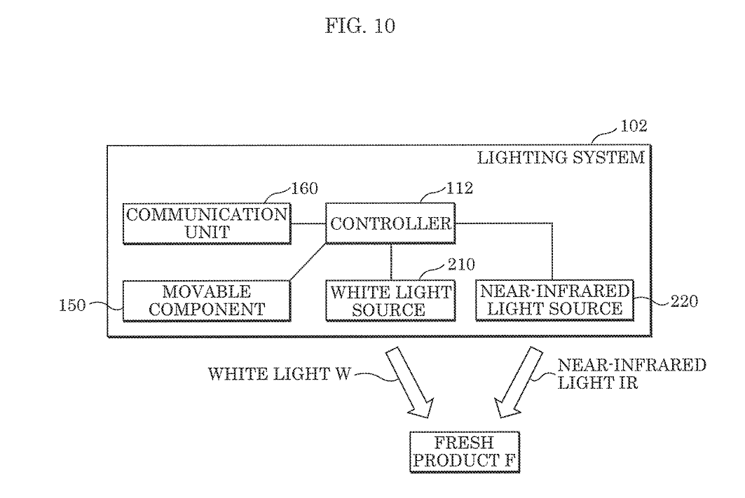

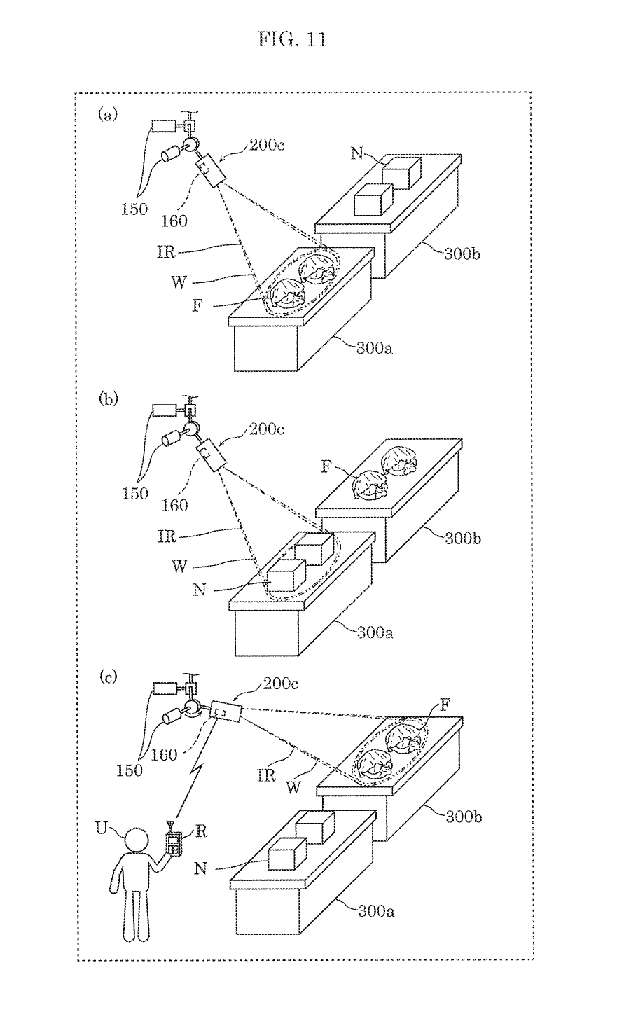

FIG. 10 is a block diagram illustrating the characteristic functional configuration of lighting system 102 according to Embodiment 3. FIG. 11 is a schematic perspective view of lighting system 102 according to Embodiment 3.

As illustrated in FIG. 10, lighting system 102 includes, in addition to the elements included in lighting system 100 according to Embodiment 1, communication unit 160 and movable component 150.

Communication unit 160 is a device that obtains information indicating the directions in which white light W and near-infrared light IR are emitted. Communication unit 160 is configured of, for example, a CPU and a communication interface (I/F). Communication unit 160 obtains the above described information from user U. The means used by user U to transmit the information is not limited. For example, user U may use remote control R to transmit the information wirelessly, and may transmit the information from a terminal such as a personal computer over a wired connection.

Here, the information is data for indicating directions in which lighting device 200c emits white light W and near-infrared light IR. The information includes, for example, the location of movable component 150 or the location of the showcase on which fresh product F is displayed, and is for specifying an amount and direction of movement of movable component 150 in order to irradiate fresh product F with near-infrared light IR and white light W. The information includes, for example, positional data indicating a position in the store. Lighting system 102 includes, for example, memory such as ROM and/or RAM, and includes, in advance, a table defining coordinates indicating positions in the store. User U transmits, to communication unit 160, coordinates indicating a position where white light W and near-infrared light IR are desired to be emitted, using remote control R. Controller 112 transmits, to movable component 150, an instruction to move lighting device 200c in accordance with the coordinates obtained by communication unit 160. Movable component 150 moves lighting device 200c to change the emission direction of white light W and near-infrared light IR to toward fresh product F (toward the coordinates indicated in the received information).

In addition to the functions of controller 110 indicated in Embodiment 1, controller 112 further transmits, to movable component 150, a signal for causing movable component 150 to operate in accordance with the information obtained by communication unit 160. Movable component 150 operates in accordance with the signal.

Movable component 150 is a device for changing the direction in which white light W and near-infrared light IR is emitted. As illustrated in FIG. 11, for example, when lighting device 200c emits both white light W and near-infrared light IR, movable component 150 is configured of a control circuit for obtaining information from controller 112 and a motor for moving lighting device 200c in accordance with the information obtained by the control circuit.

Note that movable component 150 is not limited to a certain method of changing the direction in which lighting device 200c emits light; any method may be used that changes the direction in which white light W and near-infrared light IR are emitted. For example, lighting device 200c may include a reflector that reflects near-infrared light IR and white light W and a movable device that changes the angle of the reflector, and the direction in which near-infrared light IR and white light W is emitted may be changed by the movable device changing the angle of the reflector.

In FIG. 11, (a) illustrates the position of fresh product F and the illumination positions of white light W and near-infrared light IR at first point in time t1. In FIG. 11, (b) illustrates the position of fresh product F and the illumination positions of white light W and near-infrared light IR at second point in time t2 which is after first point in time t1. In FIG. 11, (c) illustrates an instance in which the illumination positions of white light W and near-infrared light IR are changed after second point in time t2. Note that non-fresh-product N is a product that does not need to be irradiated with near-infrared light IR. Moreover, lighting device 200c illustrated in (a), (b), and (c) in FIG. 11 includes white light source 210, near-infrared light source 220, and controller 112, and emits white light W and near-infrared light IR, but illustration of, for example, white light source 210, near-infrared light source 220, and controller 112 is omitted from the drawings.

As illustrated in (a) in FIG. 11, for example, at the first point in time, fresh product F is already arranged and displayed on showcase 300a. Then, as illustrated in (b) in FIG. 11, the layout inside the store is changed, whereby fresh product F is moved to showcase 300b. In this case, as illustrated in (c) in FIG. 11, user U changes the emission directions of white light W and near-infrared light IR using remote control R.

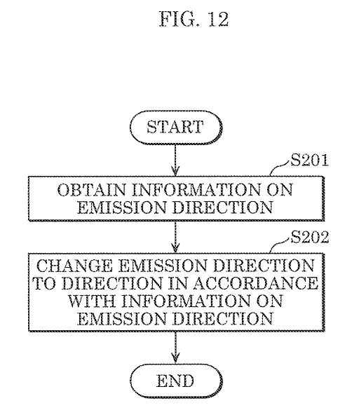

FIG. 12 is a flow chart illustrating the order of processes for changing emission direction in the lighting system according to Embodiment 3.

For example, when the position of fresh product F is changed as in the example illustrated in FIG. 11, user U uses remote control R to transmit, to communication unit 160, information indicating a direction in which white light W and near-infrared light IR are desired to be emitted. Here, for example, coordinates indicating the location in which the whole showcase is disposed are set in advance. Lighting system 102 includes memory (not illustrated in the drawings), and stores the above described coordinates in the memory in advance. User U uses remote control R to transmit, to communication unit 160, information indicating the coordinates. Communication unit 160 receives the information (step S201). Controller 112 transmits information to movable component 150 such that light is emitted in the direction indicated in the information. Movable component 150 drives lighting device 200c in accordance with the information (step S202). This makes it possible to change the illumination area of light to a position desired by user U.

Note that the information may be positional information obtained using the global positioning system (GPS). GPS refers to a system that uses satellites to identify the current position on the Earth. Remote control R uses GPS to obtain the positional information of remote control R. For example, while holding remote control R, user U moves to the vicinity of showcase 300b illustrated in (c) in FIG. 11 on which fresh product F is displayed. User U uses remote control R to transmit, to communication unit 160, the positional information obtained through GPS. Controller 112 transmits, to movable component 150, information to move lighting device 200c in accordance with the positional information obtained by communication unit 160. Movable component 150 moves lighting device 200c to change the emission direction of white light W and near-infrared light IR to toward remote control R—that is to say, toward showcase 300b on which fresh product F is displayed.

Moreover, when the lighting device that emits white light W and the lighting device that emits near-infrared light IR are provided as separate devices, user U may transmit the positional information to each of the lighting devices. Here, there is a chance that the illumination areas of white light W and near-infrared light IR on placement surface A may change depending n the position of placement surface A on which fresh product F are displayed. In such cases, for example, the spotlight diameters of white light W and near-infrared light IR may be changed by changing the position of optical component 230. More specifically, optical component 230 is a lens, and the light device holds optical component 230 so as to be capable of changing the distance between optical component 230 and white light source 210 and/or the distance between optical component 230 and near-infrared light source 220. The spotlight diameters of white light W and near-infrared light IR are changed by changing the distance between optical component 230 and white light source 210 and/or the distance between optical component 230 and near-infrared light source 220 (changing the position in which optical component 230 is held in the lighting device). White light illumination area WA and/or near-infrared light illumination area IRA on placement surface A may be changed using this method.

Moreover, there may be a plurality of lighting devices that emit white light W and a plurality of lighting devices that emit near-infrared light IR, and lighting devices may be selected such that near-infrared light illumination area IRA overlaps white light illumination area WA.

Moreover, lighting system 102 may adjust the illumination positions of white light W and near-infrared light IR by further including photosensor 130 included in the lighting system according to Embodiment 2. More specifically, photosensor 130 may be an image sensor that obtains the illumination positions of white light W and near-infrared light IR and adjusts the illumination areas of white light W and near-infrared light IR. For example, suppose that white light source 210 and near-infrared light source 220 are disposed in separate enclosures. When the location in which fresh product F is displayed changes, as described above, the emission directions of white light W and near-infrared light IR are changed in accordance with positional information. Then, photosensor 130 obtains an image of the illumination areas of white light W and near-infrared light IR. For example, the lighting device including near-infrared light source 220 includes photosensor 130 that obtains the image. When the illumination area of near-infrared light IR is not completely covered by the illumination area of white light W in the image, controller 112 operates movable component 150 so as to change the emission direction of near-infrared light IR. For example, a reference point may be provided on placement surface A of showcase 300, and movable component 150 may change the emission direction of near-infrared light IR such that the center point of the image captured by photosensor 130 overlaps the reference point. This makes it possible to precisely adjust the illumination position of near-infrared light IR and the illumination position of white light W.

### Advantageous Effects, Etc

Lighting system 102 according to Embodiment 3 includes: movable component 150 that changes an emission direction of at least one of white light W and near-infrared light IR; and communication unit 160 configured to obtain information specifying the emission direction. Movable component 150 changes the emission direction of at least one of white light W and near-infrared light IR to a direction in accordance with the information obtained by communication unit 160.

This makes it possible to easily change the direction in which light is emitted from lighting device 200, which emits near-infrared light IR and white light W.

Moreover, the information specifying the emission direction of near-infrared light IR and white light W may be positional information obtained using GPS.

With this, for example, lighting system 102 includes memory, and using information, stored in memory, for specifying coordinate positions in the store eliminates the need to change the directions in which near-infrared light IR and white light W are emitted. Accordingly, the direction in which light is emitted from lighting device 200, which emits near-infrared light IR and white light W, is changed using only simple information. In other words, lighting system 102 can have a more simple configuration.

### Other Embodiments

Hereinbefore, the lighting system has been described according to embodiments, but the present disclosure is not limited to the above embodiments.

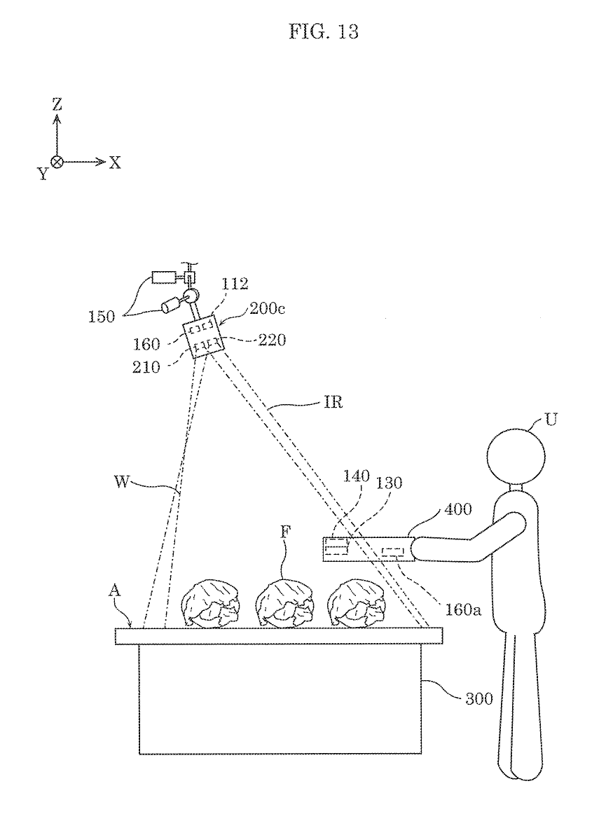

Fore example, a portable communication terminal such as a modern cellular phone or smart phone may include an image sensor such as a CMOS for taking, for example, photos. Moreover, the image sensor may have a spectral sensitivity that enables it to detect light in the wavelength range of 700 nm and longer. In these cases, photosensor 130 included in the lighting system may be used as the image sensor in the portable communication terminal. FIG. 13 is a schematic side view of a lighting system according to another embodiment.

As illustrated in FIG. 13, lighting device 200c emits near-infrared light IR and white light W toward fresh product F. User U confirms whether near-infrared light IR is being emitted from lighting device 200c by controlling photosensor 130 included in portable communication terminal 400. In other words, one lighting system according to another embodiment includes lighting device 200c and portable communication terminal 400.

For example, when user U wants to confirm whether near-infrared light IR is being emitted from lighting device 200c, user U uses portable communication terminal 400 to transmit, to communication unit 160, via communication unit 160a included in portable communication terminal 400, an instruction for interrupting the emission of light by (i.e., for turning off white light source 210. Upon obtaining the instruction via communication unit 160, controller 112 interrupts the emission of light by white light source 210. Then, user U places portable communication terminal 400 (more specifically, photosensor 130 included in portable communication terminal 400) between lighting device 200c and fresh product F, and confirms whether near-infrared light IR is being emitted. Then, portable communication terminal 400 transmits, to communication unit 160 via communication unit 160a, a signal indicating whether photosensor 130 detected near-infrared light IR, and controller 112 controls the emission of light by white light source 210 based on the signal. In this way, with a simple configuration using a preexisting portable communication terminal 400, such as a smart phone, the emission or non-emission of near-infrared light IR can be determined.

Note that emission or non-emission of near-infrared light IR can be confirmed using a screen such as the display included in portable communication terminal 400. For example, an image indicating the state of emission of white light W and near-infrared light IR as detected by photosensor 130 may be displayed on, for example, the display included in portable communication terminal 400.

Moreover, portable communication terminal 400 may include optical filter 140 that blocks light shorter than 700 nm in wavelength (more specifically, visible light). This allows photosensor 130 to precisely detect near-infrared light IR.

Moreover, controller 112 is exemplified as interrupting the emission of light by white light source 210 upon using photosensor 130 to detect near-infrared light IR, but the emission of light by white light source 210 need not necessarily be interrupted. For example, the lighting system may include storage such as memory, and a state in which near-infrared light IR is being emitted may be compared with an image of a state in which near-infrared light IR is not being emitted to determine whether near-infrared light IR is being emitted or not.

More specifically, before photosensor 130 detects near-infrared light IR, a first image may be stored in advance in the above-described storage taken in a state in which only white light W is being emitted. Then, when photosensor 130 detects near-infrared light IR, a second image taken from the same position that the first image was taken from may be obtained while white light W is being emitted. Controller 112 calculates a difference between a color component (chromaticity) of each pixel in the first and second images. When there is a difference in the color components, controller 112 determines that near-infrared light IR is being emitted, and when there is no difference, controller 112 determines that near-infrared light IR is not being emitted.

With this, controller 112 can precisely determine whether near-infrared light IR is being emitted or not even when detection of near-infrared light IR is performed by photosensor 130 in a state in which white light W is being emitted.

Moreover, portable communication terminal 400 may include a GPS function. More specifically, portable communication terminal 400 may include a GPS receiver (not illustrated in the drawings) that receives information specifying the location of portable communication terminal 400 using GPS.

Portable communication terminal 400 obtains positional information via the GPS receiver. Positional information may be sent from portable communication terminal 400 to lighting device 200c by wireless communication between communication unit 160a included in portable communication terminal 400 and communication unit 160 included in lighting device 200c that emits near-infrared light IR and white light W. The emission direction of light from lighting device 200c may be changed in accordance with the positional information. In this way, with a simple configuration using a preexisting portable communication terminal 400, such as a smart phone, the emission directions of near-infrared light IR and white light W can be changed.

Moreover, user U may use portable communication terminal 400 to cause an instruction, such as and instruction for turning on or off white light source 210 and near-infrared light source 220, or an instruction for adjusting the light output of white light source 210 and near-infrared light source 220, to be transmitted to communication unit 160a. Moreover, the lighting systems according to Embodiments 2 and 3 may be realized by lighting device 200c and portable communication terminal 400.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A lighting system that irradiates a fresh product with light, the lighting system comprising:
a white light source that emits white light; and
a near-infrared light source that emits near-infrared light having at least one peak wavelength in a wavelength range of from 700 nm to 1100 nm, inclusive, the near-infrared light at least partially overlapping an area illuminated by the white light on a placement surface on which the fresh product is placed.

2. The lighting system according to claim 1, wherein
the white light source is disposed in a first enclosure and the near-infrared light source is disposed in a second enclosure different from the first enclosure.

3. The lighting system according to claim 1, wherein
the white light source and the near-infrared light source are disposed in a common enclosure.

4. The lighting system according to claim 1, further comprising:
an optical component that focuses the white light and the near-infrared light.

5. The lighting system according to claim 1, further comprising:
a photosensor that detects at least light of wavelengths from 700 nm to 1100 nm, inclusive.

6. The lighting system according to claim 5, further comprising:
a controller that controls the white light source and the photosensor,
wherein the controller interrupts emission of light by the white light source and then causes the photosensor to detect light.

7. The lighting system according to claim 6, wherein
the controller causes the white light source to emit light when the photosensor detects the near-infrared light and causes the white light to blink when the photosensor does not detect the near-infrared light.

8. The lighting system according to claim 5, further comprising:
an optical filter that blocks light less than 700 nm in wavelength,
wherein the optical filter is located on a side of the photosensor that receives the white light.

9. The lighting system according to claim 5, wherein
the photosensor is an image sensor included in a portable communication terminal.

10. The lighting system according to claim 1, further comprising:
a movable component that changes an emission direction of at least one of the white light and the near-infrared light; and
a communication unit configured to obtain information specifying the emission direction,
wherein the movable component changes the emission direction of at least one of the white light and the near-infrared light to a direction in accordance with the information obtained by the communication unit.

11. The lighting system according to claim 10, wherein
the information is positional information obtained using global positioning system (GPS).

12. The lighting system according to claim 11, further comprising:
a portable communication terminal that receives the positional information,
wherein the communication unit obtains the positional information received by the portable communication terminal.

13. A fresh product showcase, comprising:
a placement surface on which a fresh product is placed for display;
a lighting device secured relative to the placement surface, the lighting device comprising:
a white light source that emits white light;
a near-infrared light source that emits near-infrared light having at least one peak wavelength in a wavelength range of from 700 nm to 1100 nm, inclusive; and
wherein an area on the placement surface illuminated by the near-infrared light at least partially overlaps an area on the placement surface illuminated by the white light.

14. A method of presenting a fresh product while maintaining freshness, comprising:
illuminating the fresh product with a white light source that emits white light; and
simultaneously illuminating the fresh product with a near-infrared light source that emits near-infrared light having at least one peak wavelength in a wavelength range of from 700 nm to 1100 nm, inclusive.

15. The method of claim 14, further comprising:
detecting a failure in the near-infrared light source, and automatically reducing an intensity of the white light emitted by the white light source as a result of detecting the failure.
